(19) United States
(12) Patent Application Publication
(10) Pub. No.: US 2023/0401396 A1
(43) Pub. Date: Dec. 14, 2023

(54) MOBILE APPLICATION FOR MOBILE DEVICES TO ALLOW BEVERAGES DELIVERED BY BEVERAGE VENDING MACHINES TO BE SELECTED AND PERSONALISED

(71) Applicant: Evoca S.P.A, Valbrembo (IT)

(72) Inventor: Alberto Capobianco, Valbrembo (IT)

(21) Appl. No.: 18/249,853

(22) PCT Filed: Oct. 27, 2021
(86) PCT No.: PCT/IB2021/059938

§ 371 Date: Apr. 20, 2023

(30) Foreign Application Priority Data
Oct. 27, 2020 (EP) 20204112.5
Oct. 25, 2021 (IT) 102021000027353

(51) Int. Cl. G06K 7/10; H04M 1/72406; H04M 1/72412; G06K 19/07; B65G 43/08

(52) U.S. Cl. CPC G06K 7/10366; H04M 1/72406; H04M 1/72412; G06K 19/0723; B65G 43/08

(57) ABSTRACT

A product vending system comprising:
a product vending machine;
a mobile application designed to be downloaded and executed on a consumer's personal mobile terminal and designed to cause, when executed by the user terminal, the user terminal to become configured to communicate and cooperate with the product vending machine to allow a consumer to request the product vending machine to deliver a product; and
a tag to be associated with the product vending machine and containing communication information to allow a communication to be established between the product vending machine and the mobile terminal.

The mobile application is designed to cause, when executed by the the mobile terminal, the mobile terminal to become configured to:
read the tag to extract information contained therein;
establish a communication with the product vending machine based on the communication information read from the tag;
communicate with the product vending machine to receive therefrom information on the products delivered thereby;
display a graphical user interface to allow the consumer to request the product vending machine to deliver a product; and
communicate with the product vending machine to provide it with information on a product to be delivered.

The product vending machine is designed to:
establish a communication with the user terminal;
communicate with the user terminal to receive therefrom information on a product to be delivered; and
deliver a requested product.

### CROSS-REFERENCE TO RELATED APPLICATIONS

This patent application claims priority to European patent application no. 20204112.5 filed on 27 Oct. 2020 and Italian patent application no. 102021000027353 filed on 25 Oct. 2021, the entire disclosures of which are incorporated herein by reference.

### TECHNICAL FIELD OF THE INVENTION

The present invention relates generally to product vending machines, in particular beverage vending machines, and more in particular to a mobile application for mobile devices to allow beverages delivered by beverage vending machines to be selected and personalised.

The present invention finds application in product vending machines dispensing products of any kind and in any state of matter, in particular solid or liquid food products, packaged or prepared at the moment on demand.

The present invention finds advantageous application in beverage vending machines dispensing hot or cold, packaged or so-called instant beverages, i.e., prepared on demand from liquid and/or powdered ingredients, to which the following disclosure will explicitly refer without losing generality.

The present invention may, however, find advantageous application in product vending machines dispensing products of a different kind, such as electronic products, gadgets, personal protective equipment, etc.

### STATE OF THE ART

As known, in the field of vending machines, design is increasingly focusing on the development and adoption of technologies that increase interactivity between consumers and vending machines. For this reason, the Human-Machine Interfaces (HMI) of vending machines, e.g. dispensing instant beverages, are continuously evolving to allow consumers to interact with vending machines in an increasingly sophisticated way from different perspectives.

### OBJECT AND SUMMARY OF THE INVENTION

The Applicant has observed that, in order to avoid the circulation of germs, viruses, bacteria or other pathogenic micro-organisms which can survive, even for a limited time, on surfaces and in the environment, and which can therefore lead to the spread of contagious infectious diseases, it is important to reduce contact or by-air contamination as much as possible.

In vending machines, this situation occurs in particular when several consumers gather around the beverage vending machine for the so-called coffee break, due to both the inevitable excessive interpersonal proximity (congregation) and the need for hand contact with the user interfaces, usually touchscreen displays, of vending machines for selecting and personalising beverages or edible food products.

This issue is particularly perceived in the current historical period, during the Sars-CoV-2 pandemic, as a high degree of attention to hygiene, particularly hand hygiene, is required.

The aim of the present invention is thus to provide a product vending system, in particular a beverage vending system, which overcomes the problems of the prior art.

According to the present invention, a product vending system, in particular a beverage vending machine, is provided, as claimed in the appended claims.

### BRIEF DESCRIPTION OF THE DRAWINGS

FIG. 1 schematically shows a product vending system according to the present invention.

FIG. 2 schematically shows selection and personalisation of beverages in a beverage vending machine through a consumer's mobile terminal.

FIG. 3 schematically shows two different screens of a graphical user interface of a consumer's mobile terminal for selecting and personalising beverages in a beverage vending machine.

### DETAILED DESCRIPTION OF PREFERRED EMBODIMENTS OF THE INVENTION

The present invention will now be described in detail with reference to the accompanying drawings to enable a skilled person to realize and use it. Various modifications to the embodiments presented shall be immediately clear to persons skilled in the art and the general principles disclosed herein could be applied to other embodiments and applications but without thereby departing from the scope of protection of the present invention as defined in the appended claims. Therefore, the present invention should not be considered limited to the embodiments described and shown but should be granted the widest protective scope in accordance with the features described and claimed.

Where not otherwise defined, all the technical and scientific terms used herein have the same meaning commonly used by persons of ordinary skill in the field pertaining to the present invention. In the event of a conflict, this description, including the definitions provided, shall be binding. Furthermore, the examples are provided for illustrative purposes only and as such should not be considered limiting.

In particular, the block diagrams included in the accompanying figures and hereinafter described must not be considered as a representation of the structural features, i.e. construction limitations, but must be construed as a representation of functional features, namely intrinsic properties of the devices and defined by the obtained effects i.e. functional limitations which can be implemented in different ways, so as to protect the functionality thereof (chance of functioning).

In order to facilitate understanding of the embodiments described herein, reference will be made to some specific embodiments and a specific language will be used to describe them. The terminology used herein is for the purpose of describing only particular embodiments, and is not intended to limit the scope of the present invention.

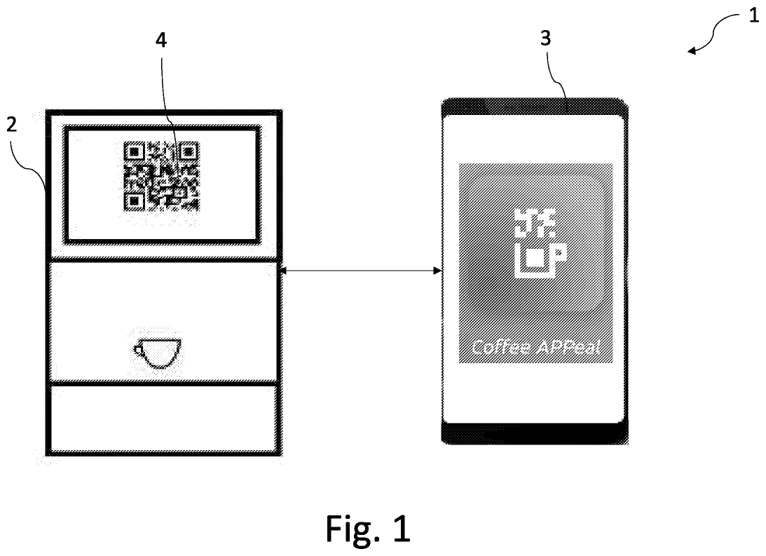

FIG. 1 shows the block diagram of a product vending system 1 including:
a product vending machine 2 provided with a user interface (HMI) comprising a display, typically a touchscreen display, and designed to allow consumers to select, personalise and control the delivery of products by the product vending machine 2;
a mobile software application, hereinafter referred to as the trade name Coffee APPeal, designed to cause, when downloaded and executed on a consumer's mobile terminal 3, such as a smartphone, a note pad, a tablet, a phablet, etc., the mobile terminal 3 to become configured to communicate and cooperate with the product vending machine 2 to allow a consumer to request the product vending machine 2 to deliver a product, in particular to select, personalise, and control the delivery of a product by the product vending machine 2; and
a tag 4 to be associated with the product vending machine 2 and containing information, described in detail hereinafter, designed to enable communication and exchange of information between the product vending machine 2 and the mobile terminal 3.

The information contained in tag 4 comprises:
communication information to enable a communication to be established between the product vending machine 2 and the mobile terminal 3;
download information to allow the Coffee APPeal to be downloaded from an app store and installed on a mobile terminal 3; and
interface information representative of a graphical user interface to be displayed by the mobile terminal 3, i.e., to be displayed on a display thereof, in order to allow a consumer to request the product vending machine 2 to deliver a product, in particular to select and personalise the product, by means of the mobile terminal 3, as well as to control delivery of the products, as described in more detail hereinafter.

In particular, the Coffee APPeal app is designed to cause, when executed by the mobile terminal 3, the mobile terminal 3 to become configured to:
read the tag 4 associated with product vending machine 2 to extract the information contained therein;
establish a communication with the product vending machine 2 based on the communication information read from the tag 4;
communicate with the product vending machine 2 to receive therefrom information on the products delivered thereby;
display a graphical user interface designed to allow the consumer to request the product vending machine 2 to deliver a product; and
communicate with the product vending machine 2 to provide it with information on a product to be delivered.

The product vending machine 2 is consequently configured to:
establish a communication with the mobile terminal 3;
communicate with the mobile terminal 3 to receive therefrom information on a product to be delivered; and
deliver the required product.

In a preferred embodiment, the product vending machine 2 is a beverage vending machine designed to deliver beverages, in particular beverages such as coffee, tea, chocolate and the like, prepared on demand from liquid and/or powder ingredients.

The graphical user interface of the mobile terminal 3 is therefore designed to allow a consumer to select a beverage to be delivered, to personalise the selected beverage, for example by varying the amount of additives it contains, such as sugar, cocoa, etc., and to control the beverage delivery process, in particular to interrupt the delivery of the selected beverage so as to obtain the desired “length” thereof.

In order to enable communication between the product vending machine 2 and the mobile terminal 3, these are provided with short-range wireless communication interfaces, each of which is able to support one or different short-range wireless communication technologies comprising one or more of the Bluetooth technology, conveniently that according to 4.0 specification, also known as Bluetooth Low Energy (BLE) or Bluetooth Smart, which also includes an e-beacon functionality to facilitate the pairing process, NFC (Near Field Communication) technology, ZigBee technology and Wi-Fi technology for connection to a wireless local area network (WLAN).

In order to facilitate establishing communication between the short-range wireless communication interfaces of the product vending machine 2 and the mobile terminal 3, the communication information contained in the tag 4 associated with the product vending machine 2 comprises identification information of the short-range wireless communication interface of the product vending machine 2, in case BLE technology is used, the so-called Local Device Name of the BLE module of the beverage vending machine 2, so as to allow the short-range wireless communication interface of the mobile terminal 3 to automatically search for and connect to the short-range wireless communication interface of the product vending machine 2 according to the protocol provided by the short-range wireless communication technology used, in the example considered the Bluetooth protocol.

The tag 4 can be made according to any of the present or future technologies.

In a preferred embodiment, the tag 4 has the form of a barcode of any type, e.g. linear or, conveniently, two-dimensional or matrix, also known as a QR code, so as to be readable, i.e. scannable, by a QR code scanner of the mobile terminal 3.

In a more basic embodiment, the QR code can be printed on an adhesive label to be attached to a cabinet of the product vending machine 2 or it can be natively printed thereon.

In a different embodiment, the QR code can be displayed on a display of the user interface of the product vending machine 2 continuously or only at particular times, with a given periodicity. For example, the QR code may be displayed in the form of a pop-up when the product vending machine 2 enters a non-delivery condition, e.g. when it is in a stand-by mode or an energy-saving mode, which occurs when the product vending machine 2 has not delivered any products for a certain period of time, e.g. one minute.

In a more advanced embodiment, the QR code may be displayed on the display of the user interface of the vending machine 2 in response to a request from a user made on the user interface of the product vending machine 2 or when the product vending machine 2 automatically recognizes the user terminal 3 approaching the product vending machine 2.

In a further different embodiment, the tag 4 may be in the form of an RFID tag, so as to be readable by an RFID reader of the mobile terminal 3, if the latter has one.

The Coffee APPeal app can be downloaded from the app store to the mobile terminal 3 based on the download information contained in the QR code, which may for example be in the form of an Internet address (URL) of the app store and, once read from the QR code via the QR code scanner of the mobile terminal 3 and duly processed by the latter, causes the mobile terminal 3 to automatically connect to the app store, from which the Coffee APPeal app can then be downloaded to the mobile terminal 3 in a known manner.

In one embodiment, the graphical user interface of the mobile terminal 3 is embedded or native, in the sense that the Coffee APPeal app is designed to cause, when executed by the mobile terminal 3, the mobile terminal 3 to become configured to display a graphical user interface by design, i.e. a graphical user interface purposely designed at a design stage.

In a preferred embodiment, the Coffee APPeal app is instead designed to cause, when executed by the user terminal 3, the user terminal 3 to become configured to construct the graphical user interface of the user terminal 3 based on the interface information contained in the QR code attached to the product vending machine 2.

In particular, in this embodiment, the Coffee APPeal app is conveniently designed to cause, when executed by the mobile terminal 3, the graphical user interface of the mobile terminal 3 to display exactly the same list of products as that displayed on the display of the user interface of the product vending machine 2, conveniently using the same names and providing the same options as those used on the product vending machine 2.

The Coffee APPeal app is further designed to cause, when executed by the mobile terminal 3, the mobile terminal 3 to become configured to communicate with the product vending machine 2 to request and receive information therefrom about the progress of the delivery of the requested product and to provide this information to the consumer by its own graphical user interface. In the case of beverage vending machines, this information may include information on the progression of the beverage delivery or even just on the start and/or end of the beverage delivery.

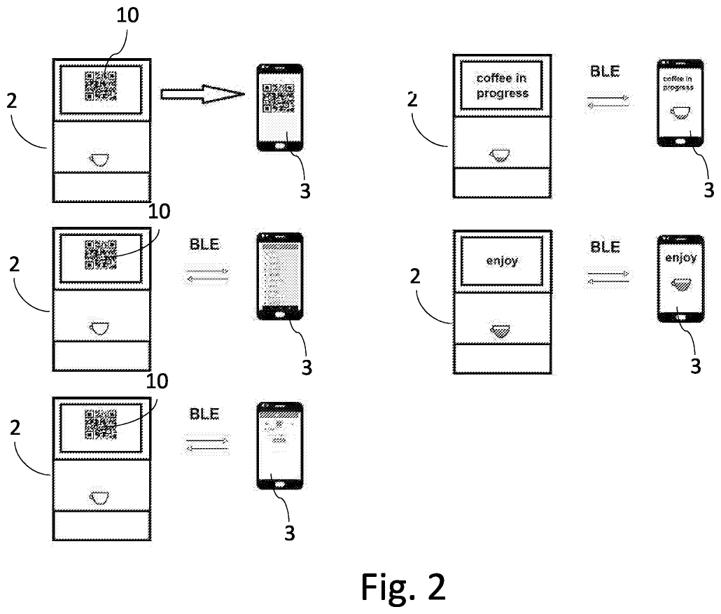

FIG. 2 shows the various steps of delivering a product according to the present invention, in particular downloading Coffee APPeal from the app store to the mobile terminal 3 (first depiction on the left), establishing communication and exchanging information between the product vending machine 2 and the user terminal 3 to select and personalise the beverage requested to be delivered (second and third depiction on the left), and the exchange of information between the product vending machine 2 and the mobile terminal 3 to obtain and display information on the delivery of the beverage requested (fourth and fifth depictions on the right).

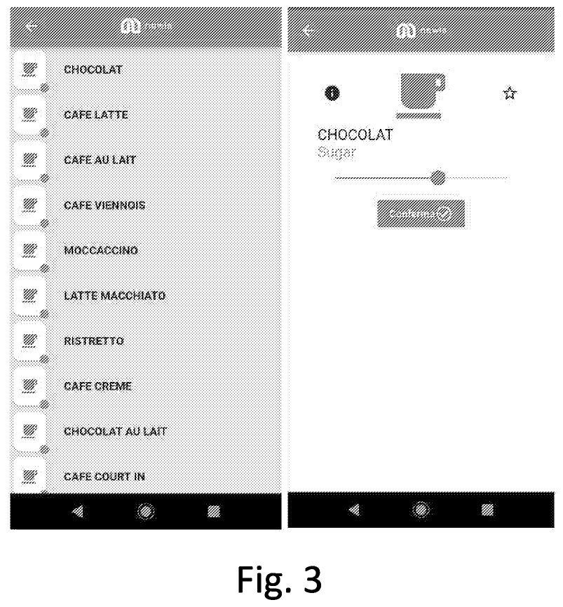

FIG. 3 shows instead beverage selection (left) and beverage personalisation (right).

Based on what has been previously described, the advantages which the present invention allows to obtain may be appreciated.

In particular, the product delivery system 1 allows a consumer to request a product to be delivered by a product vending machine 2 using his/her personal mobile terminal 3, without having to come into direct contact with the product vending machine 2, thus avoiding the possibility of coming into contact with germs, viruses, bacteria or other pathogenic micro-organisms that may lead to the spread of contagious infectious diseases.

Such an advantage finds a particular application in the present historical period, as well in everyday life; in fact, it is well known that, as occurs with smartphones for example, surfaces can be an effective vehicle for a non-negligible number of bacteria and viruses, especially if they are not regularly treated and cleaned. Thanks to the present invention, the product delivery system 1 allows a higher degree of cleanliness of the product vending machine 2 to be to maintained.

Therefore, the present invention allows to reduce the incidence of transmission of pathogenic micro-organisms between individuals who wish to use the products made available by a product vending machine 2.

Furthermore, the present invention enables consumers' mobile terminals to communicate with the product vending machines to request the delivery of products even in the absence of mobile network coverage.

Similarly, the present invention enables vending machines to deliver products requested by consumers' mobile terminals even in the absence of any connection to a wired or wireless computer network, for example the Internet, or the mobile cellular network.

1-10. (canceled)

11. A product vending system, comprising:
a product vending machine;
a mobile application downloadable and executable on a mobile terminal of a consumer and designed to cause, when executed by the mobile terminal, the mobile terminal to become configured to communicate and cooperate with the product vending machine to allow the consumer to request the product vending machine to deliver a product;
a tag to be associated with the product vending machine and containing communication information to allow a short-range communication to be established between the product vending machine and the mobile terminal and interface information representative of a graphical user interface to be displayed by the mobile terminal to allow the consumer to request the product vending machine to deliver a product;
the mobile application is further designed to cause, when executed by the mobile terminal, the mobile terminal to become configured to:
read the tag to extract the communication and interface information contained therein;
establish a short-range communication with the product vending machine based on the communication information read from the tag;
communicate with the product vending machine to receive therefrom information on the products deliverable thereby;
construct and display the graphical user interface based on the interface information read from the tag; and
communicate with the product vending machine to provide it with information indicative of a product to be delivered;
the product vending machine is configured to:
establish a short-range communication with the user terminal;
communicate with the user terminal to receive therefrom information on a product to be delivered; and
deliver a requested product.

12. The product vending system of claim 11, wherein:
the tag further comprises download information to enable the mobile application to be downloaded from an app store to the mobile terminal; and
the mobile terminal is configured to download the mobile application based on the download information read from the tag.

13. The product vending system of claim 11, wherein:
the product vending machine and the user terminal comprise respective short-range wireless communication interfaces; and
the communication information contained in the tag comprises information identifying the short-range wireless communication interface of the product vending machine.

14. The product vending system of claim 11, wherein:
the product vending machine is a beverage vending machine; and
the graphical user interface displayed by the mobile terminal is designed to allow a consumer to control delivery of a beverage requested to the beverage vending machine.

15. The product vending system of claim 14, wherein the graphical user interface displayed by the mobile terminal is further designed to allow a consumer one or more of interrupting the delivery of a beverage and personalising a beverage requested to the beverage vending machine.

16. The product vending system of claim 11, wherein:
the product vending machine comprises a user interface designed to display a graphical user interface on which products deliverable by the product vending machine are displayed; and
the mobile application is further designed to cause, when executed by the mobile terminal, the graphical user interface displayed by the mobile terminal to display the same list of products as the one displayed on the graphical user interface displayed by the product vending machine.

17. The product vending system of claim 11, wherein the tag is a QR code readable by a QR code scanner of the mobile terminal.

18. A product vending machine, a tag to be associated with the product vending machine, and a mobile application for a mobile terminal designed to cooperate to implement the product vending system of claim 11.

19. Software loadable in a product vending machine and in a mobile application for a mobile terminal and designed to cause, when executed by the product vending machine and, respectively, the mobile terminal, the product vending machine and the mobile terminal to become configured to cooperate to implement the product vending system of claim 11.
